(19) United States
(12) Patent Application Publication
(10) Pub. No.: US 2016/0019662 A1
(43) Pub. Date: Jan. 21, 2016

(54) Methods and Systems for Performing Cost Comparisons

(71) Applicant: ORACLE INTERNATIONAL CORPORATION, Redwood Shores, CA (US)

(72) Inventors: Ivan Canales Pineda, Menlo Park, CA (US); Anup Kumar Jha, Foster City, CA (US); Rixin Zhu, Fremont, CA (US); Ashish Pathak, San Ramon, CA (US); Fan Yang, Foster City, CA (US); Bryan Siu Him So, Hayward, CA (US); Ramchand Raman, Redwood Shores, CA (US)

(73) Assignee: ORACLE INTERNATIONAL CORPORATION, Redwood Shores, CA (US)

(21) Appl. No.: 14/335,387

(22) Filed: Jul. 18, 2014

(51) Int. Cl. G06Q 50/04; G06Q 10/06

(52) U.S. Cl. CPC G06Q 50/04; G06Q 10/06313

(57) ABSTRACT

Various arrangements are presented for performing comparisons of indented cost BOM (bill of material) structures of two or more items in a supply chain management system. By understanding the hierarchical nature of the indented cost BOM structure of each item and various nested relationships, it may be possible to perform complex comparisons that involve multi-level structures.

### BACKGROUND

Modern manufacturing often leads to complicated items being manufactured across multiple sites, frequently in geographically-separated locations and possibly scattered across multiple countries. To complicate matters, a same item may be manufactured using at least some different parts (e.g., components and/or subassemblies), parts that are produced using different manufacturing processes, and/or parts sourced from different vendors. Such an arrangement may result in a complicated multi-level hierarchical cost structure for an item. Such complications may make it difficult to determine similarities and differences between items, especially relating to associated costs.

### SUMMARY

Various arrangements, including methods, systems, and non-transitory computer-readable mediums (to be executed by one or more processors) are presented herein. Such arrangements may include performing a cost comparison of at least a first item and a second item. A request may be received for the cost comparison that identifies the first item and the second item. Based on the request, it may be determined that a first cost bill of materials (BOM) structure for the first item and a second cost BOM structure for the second item. The first cost BOM structure may be compared to the second cost BOM structure to identify a first group of entries that are common to the first cost BOM structure and the second cost BOM structure, the first group of entries comprising a plurality of components and resources. A second group of entries present in the first cost BOM structure but not the second cost BOM structure may be identified. A third group of entries present in the second cost BOM structure but not the first cost BOM structure may be identified. For each entry of each cost BOM structure it may be determined a cost associated with the entry. A listing of the first group of entries, the second group of entries, and the third group of entries may be created, wherein the first group of entries has, for at least one entry of the first group of entries, the first item is associated with a different cost than the second item.

Embodiments may include one or more of the following features: The first item and the second item may be a same type of item, but are manufactured at geographically-separated manufacturing facilities. The cost for a first entry present on the first cost BOM structure and the second cost BOM structure may include a cost related to overhead. A second entry present on the first cost BOM structure and the second cost BOM structure may be acquired from different suppliers for the first item and the second item. The listing of the first group of entries, the second group of entries, and the third group of entries may be output for presentation in the form of a table to a user computer system from which the request was received. The first group of entries may be listed in the listing above the second group of entries and the third group of entries. At least one entry of the first group of entries may include a plurality of components. A first entry of the first group of entries may be output for presentation as a collapsible field within the table. The collapsible field, when collapsed, may indicate a total cost for a subassembly of the first item and the second item. The collapsible field, when expanded, may list costs for each component of the subassembly for the first item and the second item.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system configured to perform a cost comparison of two or more items.

FIG. 2 illustrates an embodiment of a cost comparison engine.

FIG. 3A illustrates an exemplary embodiment of an item having multiple components and subassemblies.

FIG. 3B illustrates an exemplary embodiment of the routing of an item.

FIG. 4A illustrates an embodiment of an indented cost BOM structure.

FIG. 4B illustrates an embodiment of an indented cost BOM structure for an item that is similar to the item of FIG. 4A.

FIG. 5 illustrates an embodiment of a comparison the indented cost BOM structures of FIGS. 4A and 4B.

FIG. 6 illustrates an embodiment of a method for performing a cost comparison between two indented cost BOM structures.

FIG. 7 illustrates another embodiment of a method for performing a cost comparison between two or more indented cost BOM structures.

FIG. 8 illustrates an embodiment of a distributed system that permits the use of a remote developer computer system.

FIG. 9 illustrates a block diagram of an embodiment of a system environment by which services may be offered as cloud services.

FIG. 10 illustrates an embodiment of a computer system, which may be used to implement various embodiments detailed herein.

### DETAILED DESCRIPTION

For a user performing a cost analysis for an entity, such as a manufacturing entity, comparing two or more items may be a time-consuming process. Once an indented cost BOM structure is obtained for each of the items, the indented cost BOM structures may be compared to determine which components and subassemblies (collectively referred to as “parts”) are common across the indented cost BOM structures and which parts are particular to one of the items. In addition to comparing and contrasting parts, the use of overhead and resources may be compared and contrasted between indented cost BOM structures. It should be understood that simply because two items contain the same part, or uses the same overhead or resource, does not mean the cost associated with that particular part, resource, or overhead is the same for each item. As an example of this, consider the situation where two identical types of items are manufactured by an entity at two geographically-separated manufacturing facilities or even at two different manufacturing lines within the same facility. While a same part may be used at both facilities, the cost associated with that part for each manufacturing facility or manufacturing line may vary based on multiple factors, such as: varying quantities of the part being used, the distributor or manufacturer from which the part was acquired, taxes or duties associated with the import of the component, currency conversion rates, transportation costs, installation costs (e.g., labor costs and/or the cost associated with an amount of time a piece of equipment needs to be used to install the component on the item), preparation costs (e.g., for preparing the component for installation), and/or manufacturing costs (if the component is made in-house). While the same part may be used for the two separately-manufactured items, the costs associated with the component, such as due to overhead, resources, or acquisition may vary substantially.

To facilitate a user identifying the key differences in cost between two (or more) items, a side-by-side comparison of indented cost BOM structures of the two items (or more) may be useful. The side-by-side comparison may be presented to the user in the form of a table. In some embodiments, the table may be presented via a spreadsheet application, such as Microsoft® Excel® being executed locally by a user computer system (or presented via a user computer system and executed remotely in the form of a cloud-based application service). A cost comparison tool may result in the cost comparison being performed by a remote server system, but an interface for the cost comparison tool may be hosted locally by a user's computer system. The table may present a listing of components, subassemblies, overhead, and resources that are in common between two (or more) items and also components, subassemblies, overhead, and resources that are particular to one of the items. For each component and subassembly, one or more costs may be indicated. The cost for each item may vary, even if the same components (and the same quantity of the components) are used in both items. The cost for a particular component, subassembly, overhead, or resource may vary based on at least some of the factors previously detailed, such as the distributor from which the component was acquired or local labor costs.

It should be understood that while a significant portion of this document focuses on the comparison of two items, the same principles may be applied to comparisons of more than two items. For instance, three, four, five, ten, or dozens of items may be compared with each other using the embodiments detailed herein.

In some embodiments, an item may contain one or more subassemblies. In some situations, a user may desire to see the subassembly treated as a single component (with a single associated cost or a single group of costs for components, overhead, and resources) and in other situations the user may desire the subassembly to be broken out into its parts (with a cost associated with each part, overhead, and resource). Embodiments of the cost comparison tool detailed herein may allow for each subassembly that is made of multiple parts to be collapsed as a single entry in an indented cost BOM structure for the component or expanded into a view of the multiple parts with a cost associated with each part.

Various definitions are presented herein to facilitate understanding of the embodiments detailed herein:

Item—A finished good, also referred to as an assembly. Typically, items are made of a component, multiple components, and/or subassemblies. An item may be understood as a finished product that may be sold or otherwise distributed by an entity.

Part—a general term that can be a subassembly or a component.

Subassembly—Composed of multiple components. One or more subassemblies may be manufactured from multiple components. It is possible that a same type of subassembly be assembled with different components in certain situations. Further, it is possible that a subassembly contain additional subassemblies.

Component—The lowest level unit that is not assembled. Components are used as parts in the fabrication or creation of assemblies and/or subassemblies.

Bill of materials (BOM)—A listing that represents the various components and subassemblies present in an item. The BOM may also include the quantities of various components and subassemblies.

Indented Cost BOM Structure—A multi-level hierarchical structure list that represents the BOM and routing of an assembly. An indented cost BOM structure includes multiple components and/or subassemblies, respective quantities, cost structures, and routing details for each operation, from which the assembly is created. While many embodiments detailed herein do use an indented format, it should be understood that embodiments detailed herein are equally applicable to cost BOM structures that are not indented when presented.

Resource—A unit in a manufacturing system or process that can perform labor. For example, a resource may be a machine that assembles an item or a person that assembles a subassembly.

Overhead—A cost related to a step of manufacturing or distribution that is not directly attributed to labor or raw materials. For example, rent, electricity, and utilities can be examples of overhead.

Routing—A sequential list of operations that an assembly or subassembly goes through to be manufactured.

Item cost structure—Each item typically has five cost elements assigned to it (the cost elements typically being material cost, material overhead cost, resource cost, outside processing cost, and overhead cost). Other numbers of cost elements may also be possible. An item cost structure can have multiple levels, including a “this level cost” which represents costs that do not originate from previous subassemblies or components, and a “previous level cost,” which represents costs added during the manufacturing process by previously added subassemblies and/or components.

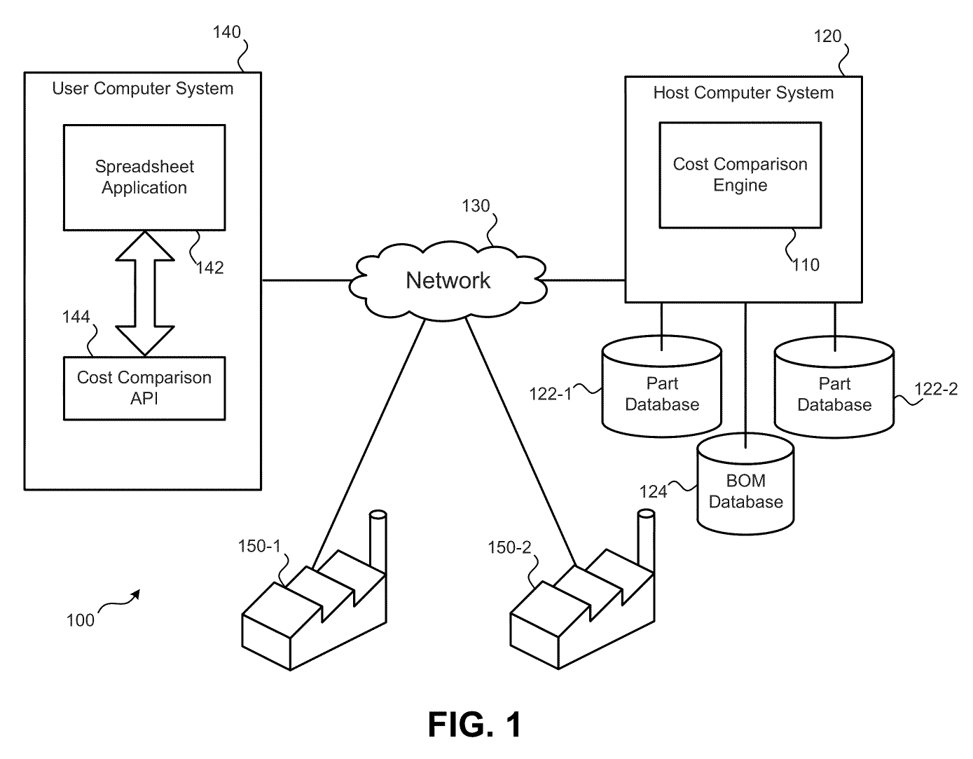

FIG. 1 illustrates an embodiment of a system 100 configured to perform a cost comparison of two or more items. System 100 may include: cost comparison engine 110, which may be hosted by host computer system 120, part databases 122, network 130, user computer system 140, which may execute spreadsheet application 142 and cost comparison application programming interface (API) 144, and manufacturing facilities 150. It should be understood that system 100 represents a simplification of various embodiments of systems that can perform a cost comparison of multiple (e.g., two or more) items; in other embodiments, additional components may be present.

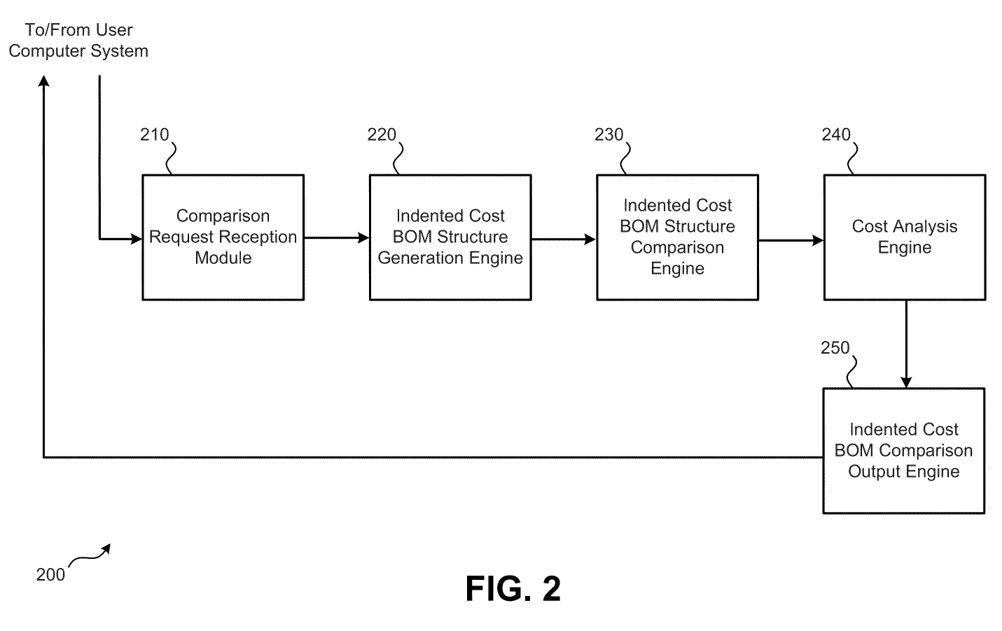

Host computer system 120 may serve to host the cost comparison engine 110 and may be part of a supply chain management system. Host computer system 120 may be a single computer server, multiple computer servers functioning in tandem, or a distributed computing system. Host computer system 120 may be configured to respond to requests from multiple user computer systems scattered geographically, such as around the world. In some embodiments, host computer system 120 is operated by a cloud computing service provider and provides cost comparison engine 110 as a service to multiple, unrelated entities. FIG. 1 illustrates system 100 being operated on behalf of a single entity. In some embodiments, host computer system 120 is operated by the same entity operating (or analyzing) manufacturing facilities 150. Further detail regarding the functionality of cost comparison engine 110 is provided in relation to cost comparison engine 200 of FIG. 2.

Part databases 122, which includes part database 122-1 and part database 122-2, are databases that maintain information about components, subassemblies, resources, and/or overhead used in the manufacture (or other form of creation) of various items. Part databases 122 may store information about the costs associated with particular components. Entries in part databases 122 may be organized by part number (e.g., such that the part number is the primary key of the database). For each part, information may be maintained that is indicative of the cost of the part. The cost of the part may be inclusive of multiple sub-costs, such as: material cost, overhead cost, and resource cost. Further breakdowns of such costs may also be possible, which can include: the cost to transport a part to a particular manufacturing facility, the taxes associated with a part when imported to a particular manufacturing facility, the cost to install the part in an item, the price at which the component is obtained from a supplier, the price of raw materials to build the part, the cost associated with the amount of time machinery is used to process/create/modify the part, etc. Such costs may be combined into an overall cost for the part or may be broken out into individual costs associated with the use of the part.

Each manufacturing location or assembly line within a manufacturing location may have a separate part database of part databases 122. Such separate part databases may be maintained to keep costs across multiple manufacturing facilities separate and accurate. In other embodiments, a particular part may have a single entry across part databases 122, but different costs may be linked with the part based on the manufacturing facility using the part. Therefore, when retrieving the costs for components associated with an item, one or more part databases of part database 122 may be accessed. In still other embodiments, whenever an item has even a single variation, a different item identifier or name may be assigned to the item. As such, by definition, a particular item may only be made by a single manufacturing line or location. While two part databases 122 are illustrated in system 100 of FIG. 1, it should be understood that this is for exemplary reasons only—one or more than two part databases 122 may be used to store component information for components used in manufacturing (or otherwise building) one or more items. If a component has one or more subcomponents, an entry in part databases 122 may be present for each subpart, along with the subpart's associated costs.

BOM database 124 may store information on various items. BOM database may store information related to indented cost BOM structures. For instance, while the various parts may be stored in databases 122, the quantities, overhead, resources and listing of which parts are present in an item may be stored in BOM database 124. When a cost comparison is requested between two items, BOM database 124 may be consulted to determine a BOM associated with each item. Two items, even if the same type of item (e.g., two items built by the manufacturer having a same make and model number), may have at least some different components and/or subassemblies (and/or different quantities of components and/or subassemblies). Such discrepancies may be due to the items being built at disparate manufacturing facilities (e.g., in different regions or countries). In some embodiments, BOM database 124 is combined with one or more of part databases 122. In some embodiments, multiple BOM databases may be present.

Network 130 represents one or more public and/or private networks that allow for communication between user computer system 140, host computer system 120, and manufacturing facilities 150. In some embodiments, part databases 122 and/or BOM database 124 is accessible via network 130. A public network may be the Internet. A private network may be a corporate intranet.

User computer system 140 may represent a computing device of a user. User computer system 140 may be a desktop computer, a laptop computer, a tablet computer, a smartphone, a head-mounted display (HMD) computer system, or any other form of computerized system that allows for a user to communicate with network 130. User computer system 140 may allow a user to interact with host computer system 120 via network 130. User computer system 140 may permit a user to submit requests for two (or more) items to be compared. The two items requesting to be compared may be the same type of item (e.g., both the same make/model of red sunglasses) or a similar type of item. In some instances, such items may be manufactured at different locations or on different assembly lines of a same manufacturing location. In some embodiments, a user may be permitted to request that items that are not the same make/model be compared (e.g., a make/model of pick-up truck with a make/model of passenger car). While embodiments detailed herein focus on two items being compared, the embodiments detailed herein can be used to compare more than two items at the same time.

User computer system 140 may execute a spreadsheet application 142 which can communicate with cost comparison engine 110 via cost comparison API 144 and network 130. Cost comparison API 144 may allow a standard spreadsheet program, such as Microsoft's® Excel® spreadsheet program to perform a comparison of indented cost BOM structures. A user may provide input to cost comparison engine 110 via spreadsheet application 142 and cost comparison API 144 and can receive output from cost comparison engine 110 via cost comparison API 144 and spreadsheet application 142. In some embodiments, a program other than spreadsheet application 142 may be used to present the comparison of indented cost BOM structures. For instance, a webpage may be created by host computer system 120 and presented via a web browser executed by user computer system 140. Such a web page may also present a comparison of two or more indented cost BOM structure s.

Manufacturing facilities 150 may be in communication with part databases 122 via host computer system 120. Manufacturing facilities 150 (manufacturing facility 150-1 and manufacturing facility 150-2) may be geographically separated such as in different cities, counties, states, or countries. While a same item may be manufactured at each of manufacturing facilities 150, the cost for manufacturing the item may vary due to different costs associated with components of the item. Part databases 122 may be kept up-to-date to reflect the costs associated with components used by manufacturing facilities 150. As such, a same component may have different costs associated with different manufacturing facilities due to: acquisition costs of the component, taxes, import duties, transportation costs, how the manufacturing facility installs the component or otherwise manipulates the component, machine time associated with the component, raw materials for the component, worker time associated with the component, etc. Such costs may be inputted to component databases 121 and rolled into the cost of a component or maintained as a cost associated with the component.

FIG. 1 illustrates a single user computer system and only two manufacturing facilities. It should be understood that such an arrangement is for exemplary purposes only—multiple user computer systems may be requesting cost comparisons of indented cost BOM structures, or other services, from host computer system 120 at the same time. Further, if host computer system 120 is functioning as a cloud service for multiple entities, the cost comparisons requested by various user computer systems may be in relation to unrelated entities (e.g., separate businesses). While two manufacturing facilities are illustrated, it should be understood that in other embodiments fewer (e.g., one) or more than two manufacturing facilities may be associated with system 100 and part databases 122.

FIG. 2 illustrates an embodiment of a cost comparison engine 200. Cost comparison engine 200 represents an embodiment of cost comparison engine 110 of FIG. 1. Cost comparison engine 200 is illustrated as being composed of multiple components. It should be understood that cost comparison engine 200 may be broken into a greater number of components or collapsed into fewer components. Each component of cost comparison engine 200 may include computerized hardware, software, and/or firmware. In some embodiments, cost comparison engine 200 is implemented as software that is executed by host computer system 120 of FIG. 1. Cost comparison engine 200 may include comparison request reception module 210, indented cost BOM structure generation engine 220, indented cost BOM structure comparison engine 230, cost analysis engine 240, and indented cost BOM comparison output engine 250.

Comparison request reception module 210 may serve to receive requests for a cost comparison from a user computer system. Comparison request reception module 210 may be configured to receive requests that indicate two or more items to be compared on a part-by-part basis (along with a comparison of overhead and/or resources). Comparison request reception module 210 may be configured to receive input from a spreadsheet program executed by a user computer system via an API. Comparison request reception module 210 may pass the requested two or more items for the comparison to indented cost BOM structure generation engine 220.

Indented cost BOM structure generation engine 220 may create an indented cost BOM structure for a requested item. Therefore, based on the item indicated in the request, a indented cost BOM structure may be either retrieved or created for the item. As such, the indented cost BOM structure requested or created by indented cost BOM structure generation engine 220 may be a hierarchical representation of all components and subparts included in the item, including overhead and/or resource costs. Indented cost BOM structure generation engine 220 may interact with BOM database 124 and one or more of part databases 122, detailed in relation to FIG. 1. An indented cost BOM structure may be requested or created by indented cost BOM structure generation engine 220 for each item indicated in the request received by comparison request reception module 210.

Indented cost BOM structure comparison engine 230 may serve to compare the indented cost BOM structures requested or created by indented cost BOM structure generation engine 220. If two items are being compared, Indented cost BOM structure comparison engine 230 may serve to first find the intersection of parts, resources, and overhead present in both indented cost BOM structures. Next, all parts, resources, and overhead of the first item, but not the second item may be identified. Third, all parts, resources, and overhead present in the second item, but not the first item may be identified. If listed in order, a listing may be created that first lists all common parts, resources, and overhead between the two items, then parts, resources, and overhead present in the first item, then finally parts, resources, and overhead present in the second item. Parts, resources, and overhead common across all items being compared may be listed at the top of a comparison table because such components may be associated with costs that make the most sense to compare across all items.

Cost analysis engine 240 may determine a total cost associated with each component present in each BOM. The total cost for parts (possibly factoring in the quantity) that are common to the first indented cost BOM structure and the second BOM may vary, due to at least some of the factors previously detailed. For example, even if the two items being compared are the same type of item, costs associated with parts may vary significantly. For each part, a total cost (also referred to as an “extended cost”) may be determined. For instance, a total cost for a part may include: acquisition fees (e.g., to buy from a vendor), transportation costs, taxes, import duties, currency conversion costs, employee time (e.g., to order and unpack the components), machine costs (e.g., costs related to having a machine dedicated to unpacking, processing, and/or installing the component), etc. This total cost may then be broken out into the individual costs (e.g., unit costs, etc.).

Cost analysis engine 240 may access one or more component databases to determine the costs associated with parts, overhead, and/or resources in each indented cost BOM structure being compared. The output from cost analysis engine 240 to indented cost BOM comparison output engine 250 may include a cost for each part, overhead, and resource present in each indented cost BOM structure being compared.

Indented cost BOM comparison output engine 250 may create a table for output to the spreadsheet program (or for presentation via some other program) of the user computer system. The table output by indented cost BOM comparison output engine 250 may be interpreted by an API executed by the user computer system such that the information of the table can be presented in a spreadsheet program to the user. Indented cost BOM comparison output engine 250 may result in matching components from each BOM being presented next to each other in the table such that the costs of the matching parts, overhead, and resources can be easily compared. Differences in parts, overhead, resources, costs, and/or quantities, may be highlighted to make readily apparent to a user.

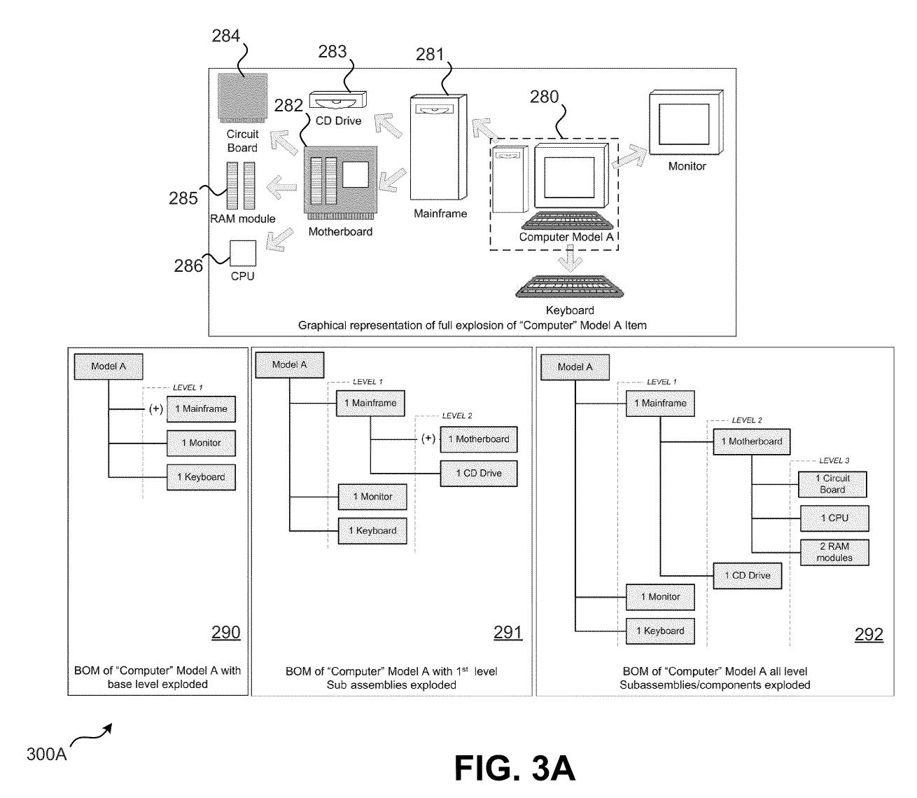

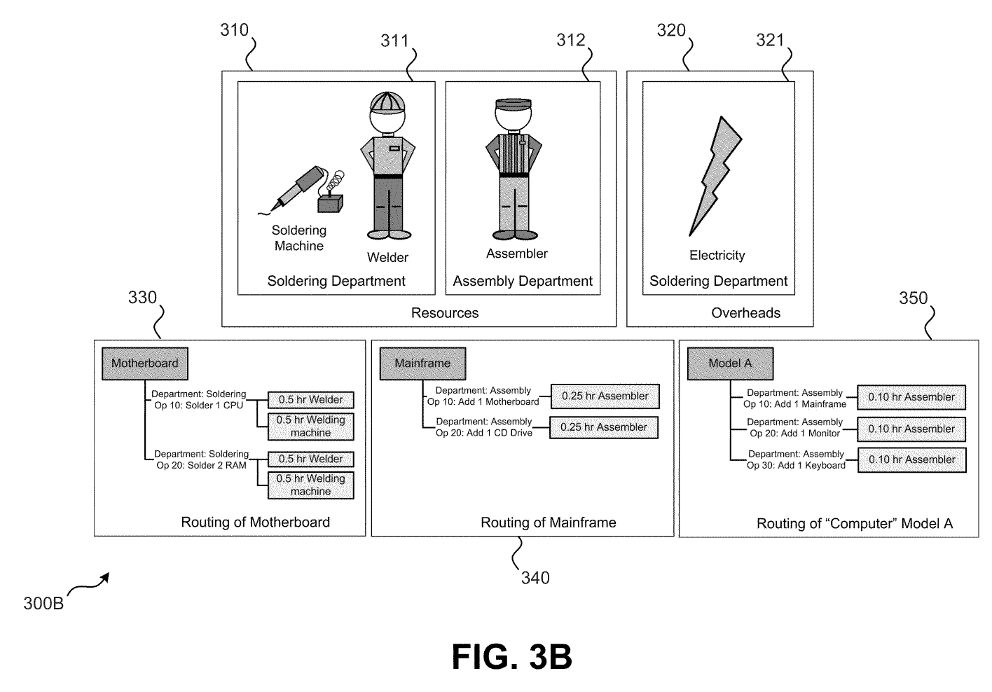

FIG. 3A illustrates an exemplary embodiment of an item having multiple components and subassemblies. It should be understood that the contents of embodiment 300A are merely exemplary and are meant to serve as an example of an item has an associated BOM having various components and subassemblies. In embodiment 300A, “Computer Model A” 280 is the item being manufactured. “Computer Model A” includes a monitor, keyboard, and mainframe. Mainframe 281 is a subassembly that contains an additional subassembly and a component. Mainframe 281 includes a motherboard 282 subassembly and a CD drive 283. Motherboard 282 includes three components: a circuit board 284, CPU 286, and RAM modules 285. It should be understood that this is a very simplified version of an item created from a variety of components and subassemblies.

Indented BOM 290 illustrates a hierarchy having mainframe 281 indicated as a subassembly that can be expanded to view components and subassemblies. The components of the monitor and keyboard are treated as components and, thus, cannot be further expanded (for instance, such components may be purchased already manufactured from a vendor). In indented BOM 291, mainframe 281 subassembly has been expanded to reveal the subassembly of the motherboard and the CD drive component. In indented BOM 291, the motherboard subassembly has been expanded to reveal its component parts of circuit board 284, RAM modules 285, and CPU 286.

FIG. 3B illustrates an exemplary embodiment 300B of the routing of an item, such as the item of FIG. 3A, in which “computer model A” is being manufactured. In embodiment 300B, various resources 310 and overhead 320 are present. The use of resources 310 and overhead 320 affect the cost of items being manufactured and may be included in indented BOM cost structures. As an example of resources, soldering department 311 and assembly department 312 are presented. Use of soldering department 311 may involve the use of soldering equipment (e.g., soldering machines, benches, workstations, etc.) and personnel, such as a welder. Equipment and personnel may be assigned a collective cost or an individual unit cost, which may be attributed to the manufacture of an item depending on the amount of time needed to perform the manufacturing task(s). Use of assembly department 312 may involve the use of an assembler, who may be paid at a different rate than a welder, thus affecting the cost that use of the resource imparts on the item being manufactured. As an example of overhead 320, electricity 321 may be consumed by soldering department 311. Such overhead affects the total cost of the item being manufactured.

Routing 330 indicates a sequential sequence of events involving soldering department 311 as applied to components that are attached to a motherboard. The amount of time required for the resource to perform the function may be useful in order to determine the cost that is attributed to the resource. For instance, if multiple manufacturing lines are present that produce the same item, with the same resource being used. The cost attributed to the resource on one manufacturing line can vary if the resource takes more time to complete a task than the equivalent resource on the other manufacturing line. Routing 340 indicates how the assembly department 312 is used sequentially to perform two tasks taking a quarter hour each to assemble the mainframe. Routing 350 indicates how assembly department 312 is used to assemble the item using various subassemblies. Installing each subassembly is attributed an amount of time, thus allowing the cost attributed to the manufacture of the item to be determined from a unit cost of the resource. Overhead may also be attributed to various stages of the manufacture process or may be distributed evenly or on the basis of time across the manufacture of multiple items.

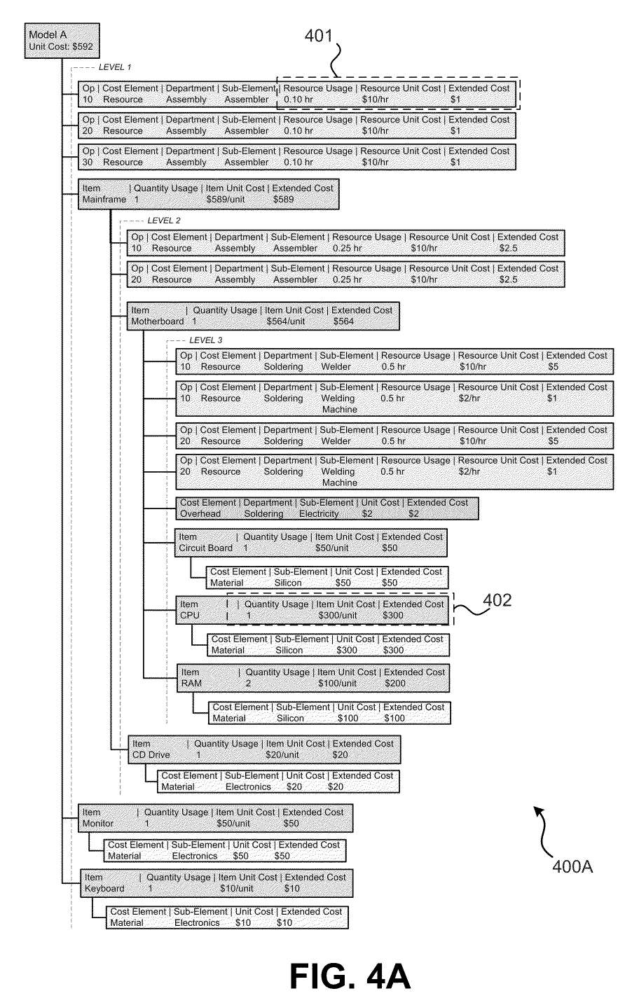

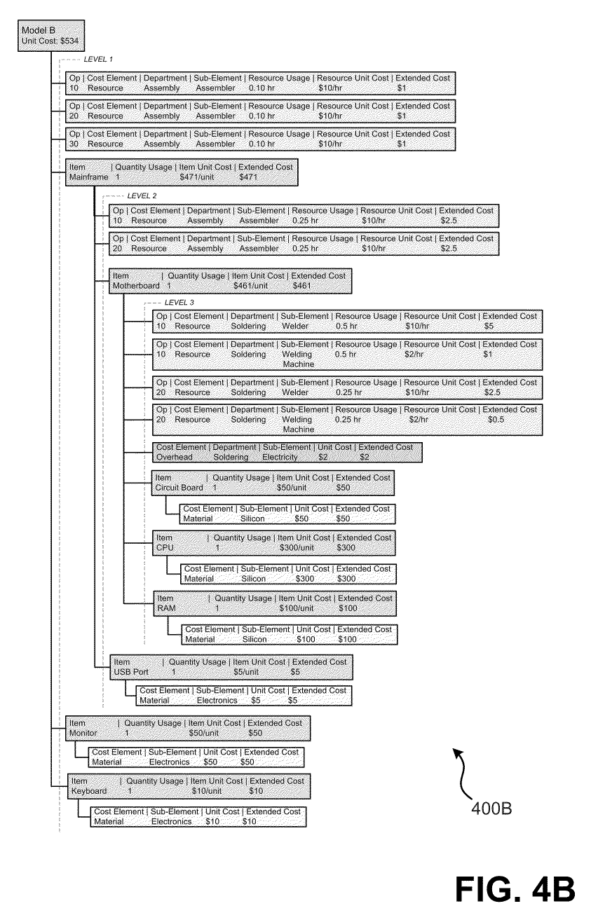

FIG. 4A illustrates an embodiment of an indented cost BOM structure 400A. For example, a user may be planning on comparing indented cost BOM structure 400A, which is for “Model A” to the indented cost BOM structure for another item. Indented cost BOM structure 400A indicates subassemblies, components, resources, and overhead. Different colors or other forms of emphasis can be used to distinguish between subassemblies, components, resources, and overhead. A user may be permitted to expand and collapse the various levels of indented cost BOM structure 400A. For subassemblies, when collapsed, a cost may be indicated that takes into account included components, additional subassemblies, overhead, and/or resources. When expanded, costs may be individually indicated for included components, additional subassemblies, overhead, and/or resources. For resources, such as indicated in region 401, a unit cost for a resource may be indicated, such as on an hourly basis. The “extended cost” may be indicative of the unit cost when the amount of time that the resource is used is taken into account: Extended Cost=(Resource Usage)*(Resource Unit Cost) For a component (or subassembly), the extended cost may be affected by the quantity, such as indicated in region 402: Extended Cost=(Quantity)*(Unit Cost).

FIG. 4B illustrates an embodiment of an indented cost BOM structure 400B for an item that is similar to the item of FIG. 4A. Indented cost BOM structure 400B is for “Model B” which is similar, but not an exact match to the indented cost BOM structure 400A of FIG. 4A for “Model A.” As can be seen, these indented cost BOM structures are similar and locating differences, even in these simplified examples, can be time consuming. As such, a user may desire to compare these indented cost BOM structures.

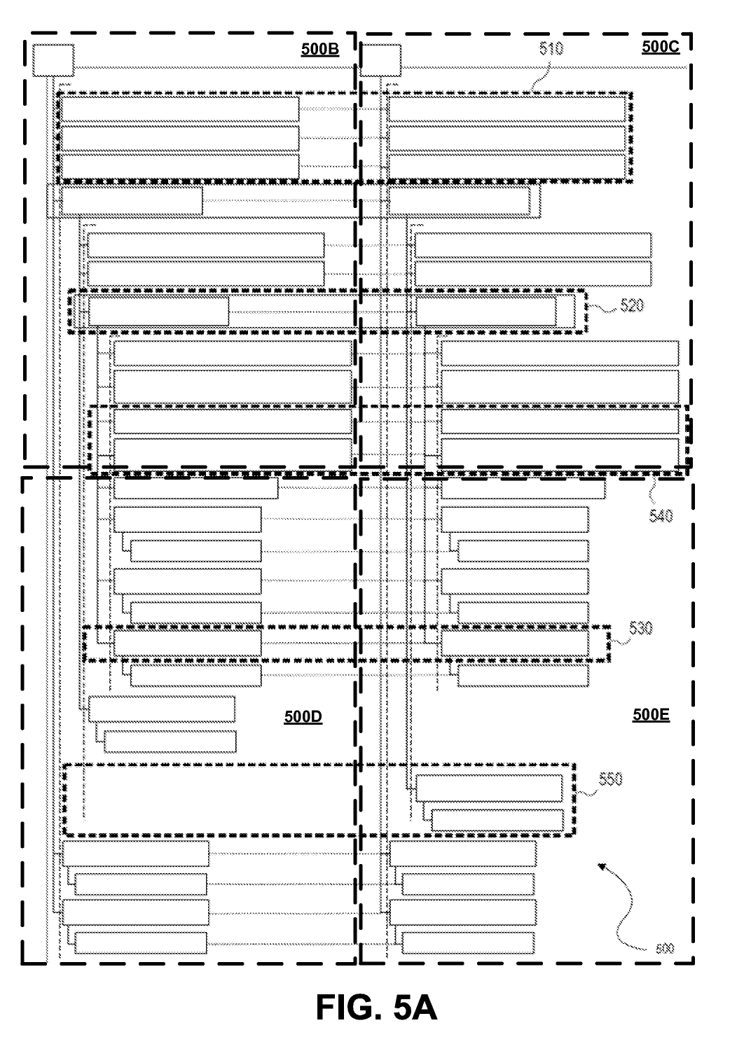

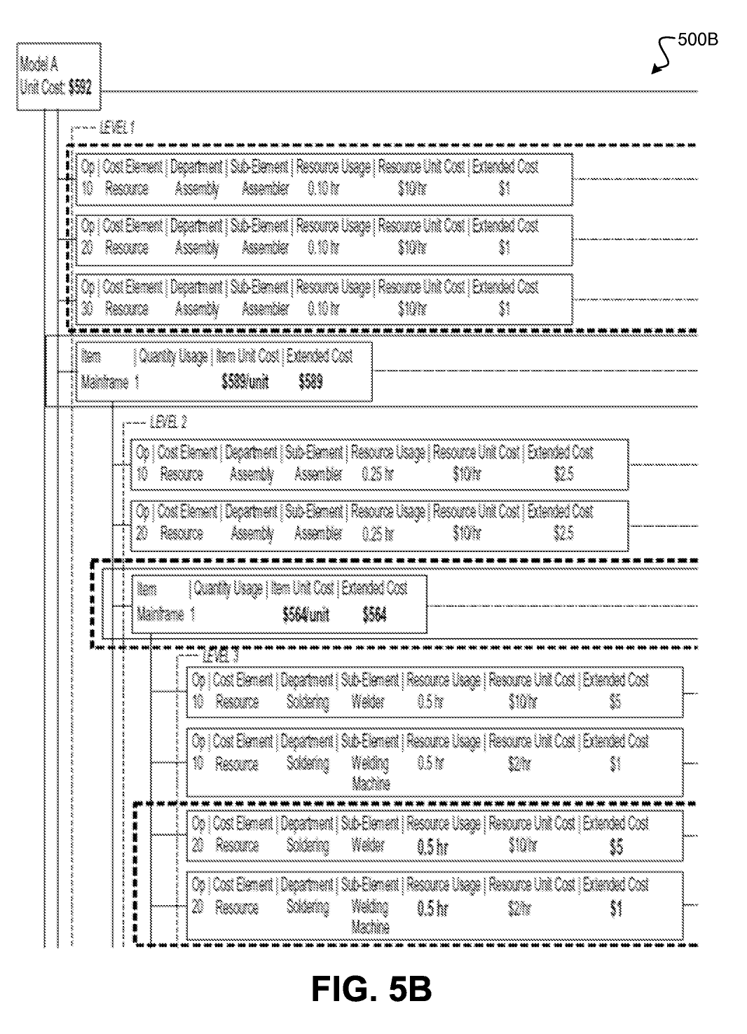

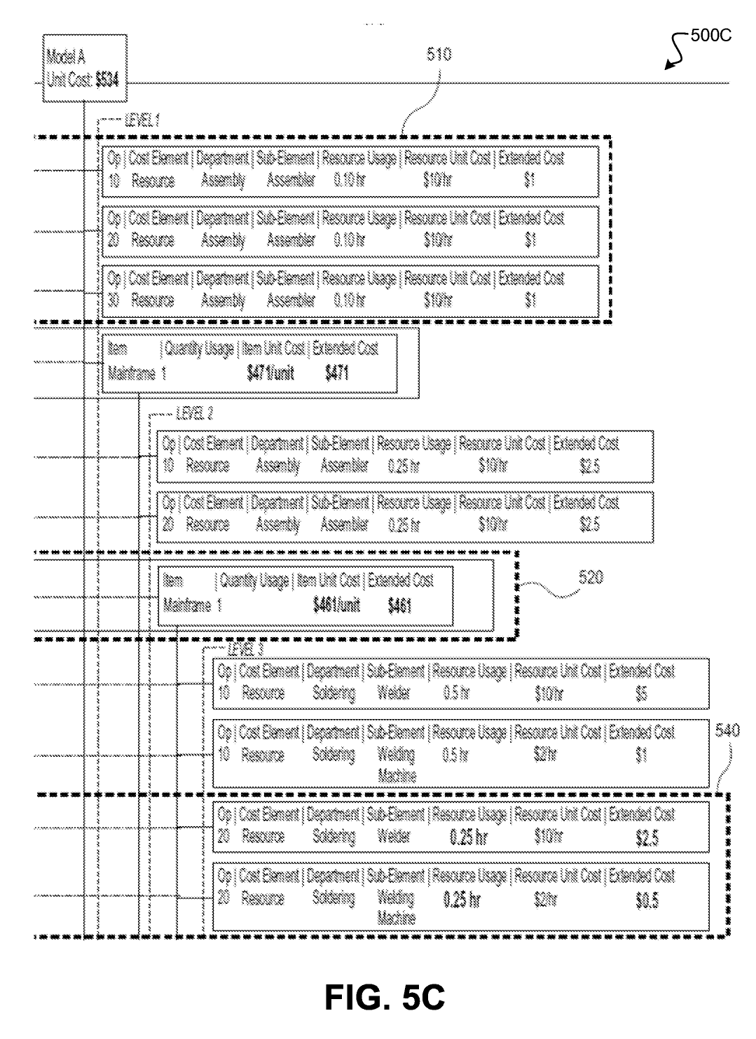

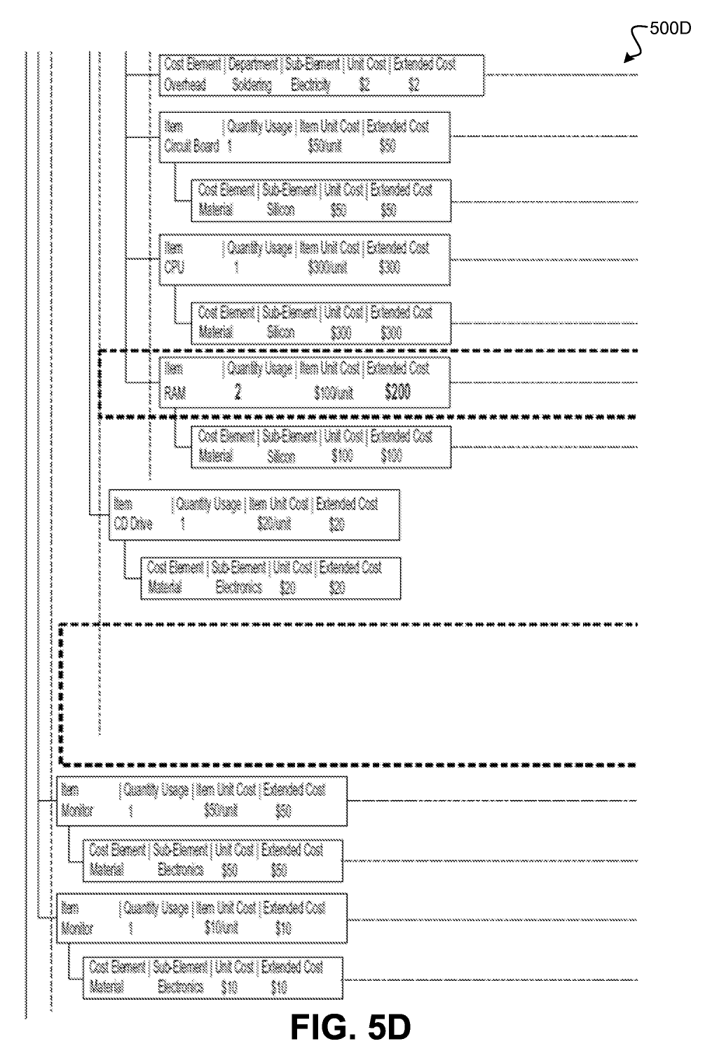

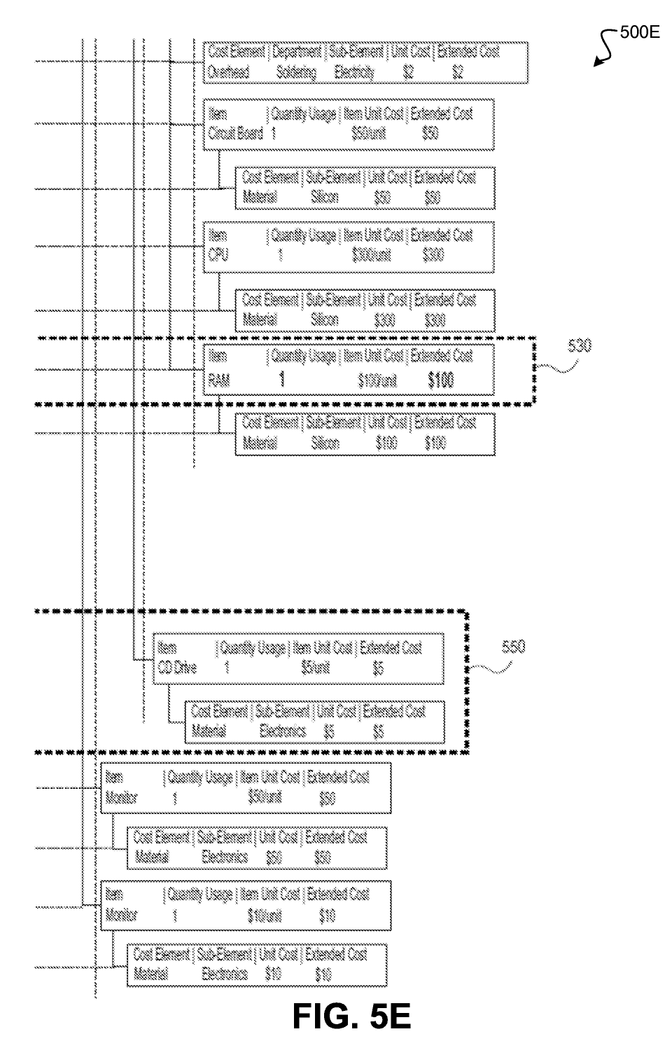

FIG. 5 illustrates an embodiment 500 of a comparison the indented cost BOM structures of FIGS. 4A and 4B. In comparison 500, the components, subassemblies, resources, and overhead are arranged in each indent cost BOM structure such that corresponding entries are listed side-by-side. While entries may be listed side-by-side, quantities, unit costs, and extended costs may vary between the entries.

As can be noticed, the prices vary between the two indented cost BOM structures for various entries. In embodiment 500, various differences between the two indented cost BOM structures are emphasized. In some embodiments, highlighting or other forms of emphasis may be used to bring a viewer's attention to entries that differ from the corresponding entry in the other indent cost BOM structure. Corresponding entries 510 match between the two indented cost BOM structures in cost and quantity, and are therefore not emphasized. Corresponding entries 520 are for the same subassembly, but have different item unit costs and extended costs, and are therefore emphasized. Corresponding entries 540 are for the same type of resource, but have different usage times, resulting in different extended cost. As such, corresponding entries 540 are emphasized. Corresponding entries 530 are emphasized because the quantities are different, resulting in different extended costs, despite being the same type of component. In some embodiments, the specific value for a given component, subassembly, resource, or overhead that result in the discrepancy between the two BOMs are emphasized to attract a user's attention. Entries that have no match, such as entries 550 can be shown without a corresponding entry on the other indented cost BOM structure.

When such a comparison view is presented to a user, the user may be permitted to expand and collapse individual levels of the indented cost BOM structures. If a particular level of a indented cost BOM structure is expanded or collapsed, the same action may be performed on the one or more other indented cost BOM structures also being presented as part of the comparison, such that corresponding entries remain presented side-by-side.

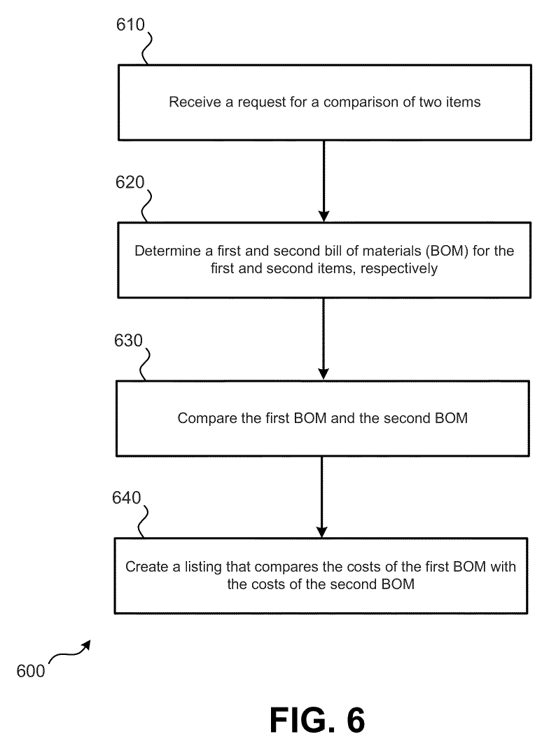

Various methods may be performed using system 100 and cost comparison engine 200 of FIGS. 1 and 2. FIG. 6 illustrates an embodiment of a method 600 for performing a cost comparison. Each step of method 600 may be performed using a cost comparison engine, such as cost comparison engine 110 and cost comparison engine 200 of FIG. 2. As such, each step of method 600 may be performed by one or more computers functioning as a computer system, such as host computer system 120 of FIG. 1. Means for performing method 600 can include one or more computing devices functioning in concert, such as in a distributed computing arrangement.

At step 610, a request may be received for a comparison of at least two items. It should be understood that the request may specify two or more items. For the remainder of the exemplary embodiment of method 600, it is assumed that the request specifies only two items to be compared. The request received at step 610 may be received via a spreadsheet program of a user computer system or some other application being executed locally. Alternatively, a web-based interface, such as a webpage via a web browser may be used to generate the request. While in some embodiments the spreadsheet program is executed by the user computer system, the request may be transmitted to a remote computer system, such as host computer system 120 of FIG. 1, to perform the cost comparison. As such, the spreadsheet program may serve as the interface for a user to request and view the cost comparison, but the processing for the cost comparison may be performed remotely by the host computer system 120. Referring to cost comparison engine 200 of FIG. 2, step 610 may be performed by comparison request reception module 210.

At step 620, a first and second indented cost BOM structure may be created or retrieved for the first item and the second item. Cost information for each entry (e.g., parts, overhead, resources) in the indented cost BOM structure may also be calculated and/or retrieved as part of step 620.

The indented cost BOM structure for each item may include all components, subassemblies, overhead, and resources that are used in manufacturing or otherwise producing the items. A quantity for a component may be listed because, for example, a particular type of component to be used multiple times in an item. The indented cost BOM structure for each item may have been previously created and stored to a database, such as BOM database 124 of FIG. 1. If two items of the same type are being compared, it is possible that one or more components of the two items may vary—thus causing the indented cost BOM structures to not match on a component-by-component basis or even on a subassembly-by-subassembly basis. Referring to cost comparison engine 200 of FIG. 2, step 620 may be performed by indented cost BOM structure generation engine 220.

At step 630, the first indented cost BOM structure and the second indented cost BOM structure are compared. Components, subassemblies, overhead, and resources that are common to each BOM may be identified. The comparison may begin from the lowest (e.g., most indented) level of the indented cost BOM structures. Next, components, subassemblies, resources, and overhead that are particular to the first indented cost BOM structure may be identified. Next, components, subassemblies, overhead, and resources that are particular to the second item may be identified. Differences in quantities, unit cost, time and extended cost for the items, components, subassemblies, resources, and overhead entries may be identified. Step 630 may be performed by indented cost BOM structure comparison engine 230 of cost comparison engine 200 of FIG. 2.

As part of the comparison, components, subassemblies, resources, and overhead that are present in each indented cost BOM structure may be identified by starting from the lowest level of the indented cost BOM structure. Components, subassemblies, resources, and overhead may be required to be on the same level in each indented cost BOM structure in order to be deemed a match. Two components, subassemblies, resources, and overhead may also require assigned identifiers match between the entries for a match to be deemed.

At step 640, a graphical or textual representation may be created that compares the costs of the components, subassemblies, resources, and overhead on the first indented cost BOM structure with the second indented cost BOM structure. In some embodiments, such a representation may be presented via a spreadsheet program. In other embodiments, a graphical arrangement that does not rely on a spreadsheet, such as presented in FIG. 5A may be created for presentation. The first portion of the generated representation may present items that are in common between the two indented cost BOM structures (but not necessarily having the same unit cost, extended cost, quantity, etc.). For entries that match exactly (e.g., same identifier, same quantity, unit cost, extended cost, usage) between the two indented cost BOM structures, the entries may be listed side-by-side, such that a user can view the entries. No emphasis may be made on the entry since the entries are an exact match. For entries that are a match (e.g., same identifier), but contain differences, such as a difference in quantity, unit cost, extended cost, usage, etc.), highlighting or some other form of emphasis may be used to draw a user's attention to the difference, which may result in a different extended cost for the corresponding entries.

Following the comparison of components, subassemblies, resources, and overhead that match between each BOM, a listing of each component that is not common to both indented cost BOM structures may be presented, such as entries particular to the first indented cost BOM structure followed by entries particular to the second indented cost BOM structure. The listing of step 650 may be configured for being output to a spreadsheet program of a user's computer system as a relational table, such that the listing is presented in the form of a table in a worksheet of the executing spreadsheet program. The user may be permitted to drill down into the sub-costs for various entries to investigate the costs associated with a particular entry. The table may also present a total cost for the item and the item's subassemblies, which may be a summation of the total costs of all of the parts, resources, and overhead that are present on the indented cost BOM structure of the item. Step 650 may be performed by indented cost BOM comparison output engine 250 of cost comparison engine 200 of FIG. 2.

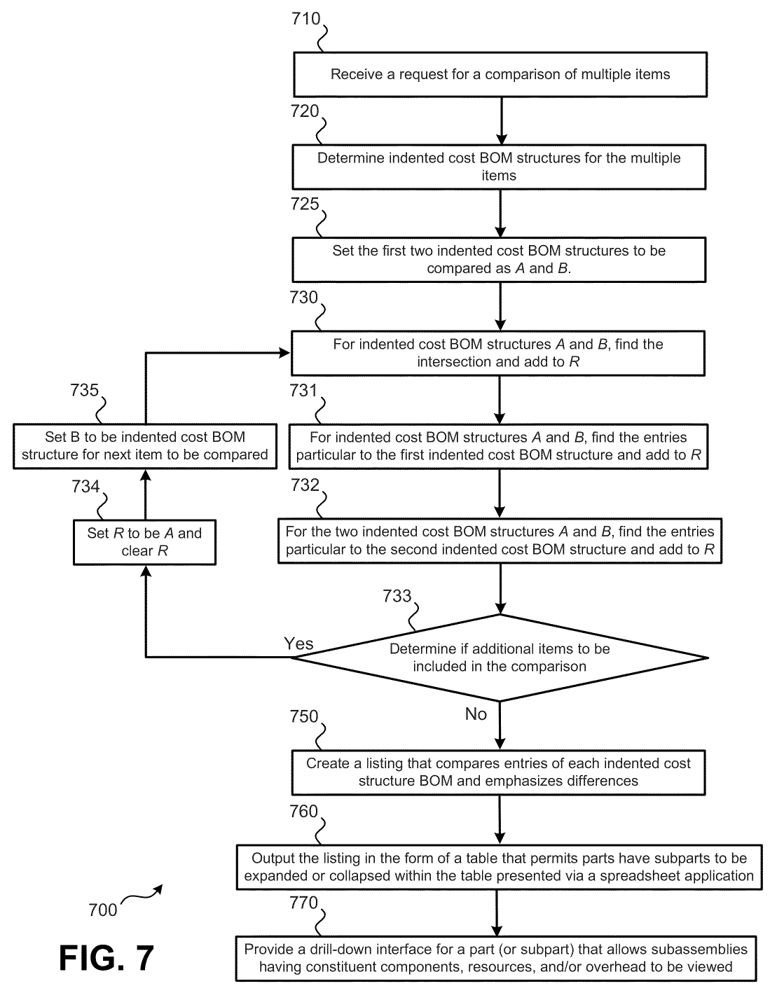

FIG. 7 illustrates another embodiment of a method 700 for performing a cost comparison. Method 700 may be used for comparing multiple BOMs, such as two, three, or more than three indented cost BOM structures. Each step of method 700 may be performed using a cost comparison engine, such as cost comparison engine 110 and cost comparison engine 200 of FIGS. 1 and 2, respectively. As such, each step of method 700 may be performed by one or more computers functioning as a computer system, such as host computer system 120 of FIG. 1. Means for performing method 700 can include one or more computing devices functioning in concert, such as in a distributed computing arrangement. Method 700 may be a more detailed embodiment of method 600 of FIG. 6; as such, each step performed as component of method 600 may also be performed in method 700.

At step 710, a request may be received for a comparison of at least two items (e.g., three, four, ten items). The items being compared may represent the same type of item being manufactured at different facilities, which may be geographically separated, the same type of item being manufactured using different assembly lines at the same facility, or different items. The request received at step 710 may be received via a spreadsheet program of a user computer system. While the spreadsheet program is executed by the user computer system, the request may be transmitted to a remote computer system, such as host computer system 120 of FIG. 1, to perform the cost comparison. As such, the spreadsheet program may serve as the interface for a user to request and view the results of the cost comparison, but the processing for the cost comparison may be performed remotely from the user computer system by the host computer system 120. Other arrangements may be used by a user to request a comparison of indented cost BOM structures. Referring to cost comparison engine 200 of FIG. 2, step 710 may be performed by comparison request reception module 210.

At step 720, the indented cost BOM structures may be created or retrieved for the items to be compared. Then the indented cost BOM structure for each item may include all components, subassemblies, resources, and overhead that are used in manufacturing or otherwise producing the items. Quantities for entries on the indented cost BOM structures may be listed, for example, it may be common for a particular type of component to be used multiple times in an item. The indented cost BOM structures for each item may have been previously created and stored to a database, such as BOM database 124 of FIG. 1. At step 725, a first indented cost BOM structure to be included in the comparison may be set as A and a second indented cost BOM structure to be included in the comparison may be set as B.

At step 730, the first indented cost BOM structure (A) and the second indented cost BOM structure (B) may begin being compared by determining the intersection of the indented cost BOM structures. First, components that are present in both BOMs may be identified. A first intersection may be performed between the first and second BOM according to equation 1 to get a set of all components in common to the two BOMs. When step 730 is initially performed, R may be empty.

R=R+A∩B Eq. 1

In equation 1, R represents the set of components, subassemblies, resources, and overhead, as organized into various levels, in the first indented cost BOM structures and the second indented cost BOM structure of the first item and the second item being compared, respectively. Equations 2 and 3, which may be performed as steps 731 and 732, may then be evaluated to determine the components, subassemblies, resources, and overhead present only in A and only in B, respectively.

R=R+(A−A∩B) Eq. 2

R=R+(B−A∩B) Eq. 3

At this point R represents the components, subassemblies, overhead, and resources of both the first and second items. If a third item's indented cost BOM structure is to be included in the comparison, (C), a determination at step 733 may be made to proceed to step 734. If all indented cost BOM structures to be included in the comparison have been compared, method 700 may proceed to step 750. At step 734, R may be stored as A and R may be cleared. B may be defined as C, the next indented cost BOM structure to be included in the comparison, at step 735. Method 700 may then repeat steps 730 through 733 until all of the items to have their indented cost BOM structures compared are included in the comparison.

A component may be determined to be present in all three BOMs if the component numbers match. After a listing of components present in all three BOMs is determined, components present in two of the BOMs may be identified. Last, components that are present in the first item, but not the second or third item may be identified, components that are present in the second item, but not the first or third item may be identified, and components that are present in the third item, but not the first or second item may be identified. Steps 730-735 may be performed by indented cost BOM structure comparison engine 230 of cost comparison engine 200 of FIG. 2.

At step 750, a side-by-side comparison may be created for the indented cost BOM structures that compares the parts, overhead, resources, costs, quantities, of the indented cost BOM structures being compared, such as in FIG. 5. For entries that match among the indented cost BOM structures, the prices for each component may be listed side-by-side, such that a user can see how the cost for the same component varies by item (and/or manufacturing facility). Following the comparison of components that match between each indented cost BOM structure, a listing of each component that is not common to the compared indented cost BOM structure may be presented, such as components particular to at least two of the indented cost BOM structures; finally, components may be listed that are particular to only one of the indented cost BOM structures (e.g., component particular to the first indented cost BOM structure, followed by components particular to the second indented cost BOM structure, then components particular to the third indented cost BOM structure). Step 750 may be performed by indented cost BOM comparison output engine 250 of cost comparison engine 200 of FIG. 2.

At step 760, the listing may be output in the form of a table to a spreadsheet program (or other form of program configured to present) executed locally by the user computer system. Within the table presented in the spreadsheet program, by selecting a part, overhead, or resource, the user may be able to see details related to the component's cost, such as sub-costs associated with specific aspects of the component. The listing of step 750 may be configured for being output to a spreadsheet program of a user's computer system as a table in step 760, such that the listing is presented in the form of a table in a worksheet of the executing spreadsheet program. The table may also present a total cost for the item, which may be a summation of the total costs of all of the components that are present on the indented cost BOM structure of the item.

A user may be permitted to expand subassemblies such that the costs associated with each component (or further subassemblies) are present, the user may also collapse subassemblies, such that just a total cost for the subassembly is presented. If the subassembly is present on multiple BOMs, by the user requesting the subassembly be expanded or collapsed for one BOM, the subassembly may be similarly expanded or collapsed for each other BOM on which the subassembly is present. For each component, a user may be permitted to drill down into multiple costs for the component. The hierarchy may be as deep as necessary to encapsulate all subassemblies.

At step 770, a drill-down interface may be presented if a user requests, such as via the spreadsheet program, details on the costs associated with a component or subassembly (or overhead or resource). The user may be permitted to drill down into the sub-costs for various components to investigate the costs associated with a particular component, subassembly, resource, or overhead. If this component is present on multiple indented cost BOM structure, the sub-costs may be compared in the drill-down interface for the user. In some embodiments, the user is prohibited from altering sub-costs to see how the total cost of an item is affected. In other embodiments, modifications of costs or sub-costs is prohibited.

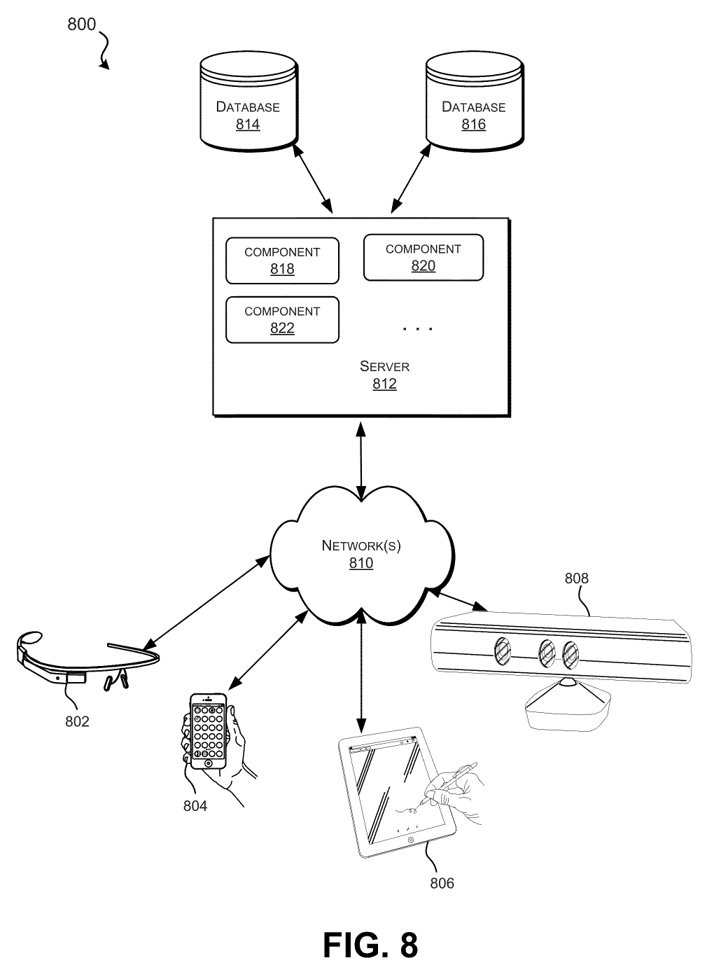

FIGS. 8-10 provide additional details on how a distributed system may be implemented that allows user and developers to remotely interact with a web service computer system. FIG. 8 illustrates an embodiment of a distributed system 800 that permits a user computer system to interact with a cost comparison engine. In the illustrated embodiment, distributed system 800 includes one or more client computing devices 802, 804, 806, and 808 (which may represent user computer systems), which are configured to execute and operate a client application such as a web browser, proprietary client (e.g., Oracle® Forms, Microsoft® Excel®), or the like over one or more network(s) 810. Server 812 (which may be the host computer system) may be communicatively coupled with remote client computing devices 802, 804, 806, and 808 via network 810.

In various embodiments, server 812 may be adapted to run one or more services or software applications provided by one or more of the components of the system. In some embodiments, these services may be offered as web-based or cloud services or under a Software as a Service (SaaS) model to the users of client computing devices 802, 804, 806, and/or 808. Users operating client computing devices 802, 804, 806, and/or 808 may in turn utilize one or more client applications to interact with server 812 to utilize the services provided by these components.

In the configuration depicted in the figure, the software components 818, 820 and 822 of system 800 are shown as being implemented on server 812. In other embodiments, one or more of the components of system 800 and/or the services provided by these components may also be implemented by one or more of the client computing devices 802, 804, 806, and/or 808. Users/developers operating the client computing devices may then utilize one or more client applications to use the services provided by these components. These components may be implemented in hardware, firmware, software, or combinations thereof. It should be appreciated that various different system configurations are possible, which may be different from distributed system 800. The embodiment shown in the figure is thus one example of a distributed system for implementing an embodiment system and is not intended to be limiting.

Client computing devices 802, 804, 806, and/or 808 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS®, Windows® Phone, Android®, BlackBerry® 10, Palm® OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 802, 804, 806, and 808 may be any other electronic device, such as a thin-client computer, an Internet-enabled gaming system (e.g., a Microsoft Xbox gaming console with or without a Kinect® gesture input device), and/or a personal messaging device, capable of communicating over network(s) 810.

Although exemplary distributed system 800 is shown with four client computing devices, any number of client computing devices may be supported. Other devices, such as devices with sensors, etc., may interact with server 812.

Network(s) 810 in distributed system 800 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 810 can be a local area network (LAN), such as one based on Ethernet, Token-Ring and/or the like. Network(s) 810 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 812 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 812 may be adapted to run one or more services or software applications described in the foregoing disclosure. For example, server 812 may correspond to a server for performing processing described above according to an embodiment of the present disclosure.

Server 812 may run an operating system including any of those discussed above, as well as any commercially available server operating system. Server 812 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include, without limitation, those commercially available from Oracle, Microsoft, Sybase, IBM (International Business Machines), MySQL, other open-source programs, and the like.

In some implementations, server 812 may include one or more applications to analyze and consolidate data feeds and/or event updates received from users of client computing devices 802, 804, 806, and 808. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 812 may also include one or more applications to display the data feeds and/or real-time events via one or more display devices of client computing devices 802, 804, 806, and 808.

Distributed system 800 may also include one or more databases 814 and 816. Databases 814 and 816 may reside in a variety of locations. By way of example, one or more of databases 814 and 816 may reside on a non-transitory storage medium local to (and/or resident in) server 812. Alternatively, databases 814 and 816 may be remote from server 812 and in communication with server 812 via a network-based or dedicated connection. In one set of embodiments, databases 814 and 816 may reside in a storage-area network (SAN). Similarly, any necessary files for performing the functions attributed to server 812 may be stored locally on server 812 and/or remotely, as appropriate. In one set of embodiments, databases 814 and 816 may include relational databases, such as databases provided by Oracle®, that are adapted to store, update, and retrieve data in response to SQL-formatted commands.

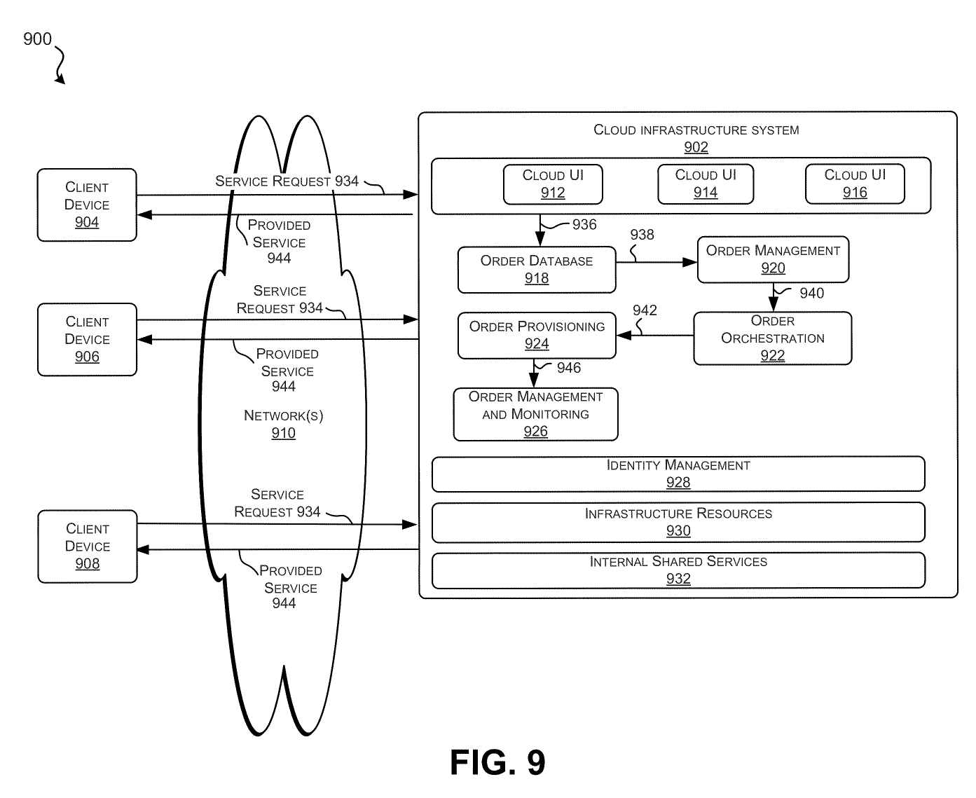

FIG. 9 illustrates a block diagram of an embodiment of a system environment by which services may be offered as cloud services. In the illustrated embodiment, system environment 900 includes one or more client computing devices 904, 906, and 908 (which can include user computer systems) that may be used by users to interact with a cloud infrastructure system 902 (e.g., the host computer system) that provides cloud services. The client computing devices may be configured to operate a client application such as a web browser, a proprietary client application (e.g., Oracle® Forms, Microsoft® Excel®), or some other application, which may be used by a user of the client computing device to interact with cloud infrastructure system 902 to use services provided by cloud infrastructure system 902.

It should be appreciated that cloud infrastructure system 902 depicted in the figure may have other components than those depicted. Further, the embodiment shown in the figure is only one example of a cloud infrastructure system that may incorporate an embodiment of the invention. In some other embodiments, cloud infrastructure system 902 may have more or fewer components than shown in the figure, may combine two or more components, or may have a different configuration or arrangement of components.

Client computing devices 904, 906, and 908 may be devices similar to those described above for 802, 804, 806, and 808. Although exemplary system environment 900 is shown with three client computing devices, any number of client computing devices may be supported. Other devices such as devices with sensors, etc. may interact with cloud infrastructure system 902.

Network(s) 910 may facilitate communications and exchange of data between client computing devices 904, 906, and 908 and cloud infrastructure system 902. Each network may be any type of network familiar to those skilled in the art that can support data communications using any of a variety of commercially-available protocols, including those described above for network(s) 810.

Cloud infrastructure system 902 may comprise one or more computers and/or servers that may include those described above for server 812. In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like (in addition to the compilation, execution, and debugging functionality previously described). Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 902 may include a suite of applications, middleware, and database service offerings that are delivered to a customer in a self-service, subscription-based, elastically scalable, reliable, highly available, and secure manner. An example of such a cloud infrastructure system is the Oracle® Public Cloud provided by the present assignee.

In various embodiments, cloud infrastructure system 902 may be adapted to automatically provision, manage and track a customer's subscription to services offered by cloud infrastructure system 902. Cloud infrastructure system 902 may provide the cloud services via different deployment models. For example, services may be provided under a public cloud model in which cloud infrastructure system 902 is owned by an organization selling cloud services (e.g., owned by Oracle) and the services are made available to the general public or different industry enterprises. As another example, services may be provided under a private cloud model in which cloud infrastructure system 902 is operated solely for a single organization and may provide services for one or more entities within the organization. The cloud services may also be provided under a community cloud model in which cloud infrastructure system 902 and the services provided by cloud infrastructure system 902 are shared by several organizations in a related community. The cloud services may also be provided under a hybrid cloud model, which is a combination of two or more different models.

In some embodiments, the services provided by cloud infrastructure system 902 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 902. Cloud infrastructure system 902 then performs processing to provide the services in the customer's subscription order.

In some embodiments, the services provided by cloud infrastructure system 902 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle®) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle® Java Cloud Service (JCS), Oracle® Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 902 may also include cloud infrastructure system 930 for providing the resources used to provide various services to customers of the cloud infrastructure system. In one embodiment, cloud infrastructure system 930 may include pre-integrated and optimized combinations of hardware, such as servers, storage, and networking resources to execute the services provided by the PaaS platform and the SaaS platform.

In some embodiments, resources in cloud infrastructure system 902 may be shared by multiple users and dynamically re-allocated per demand. Additionally, resources may be allocated to users in different time zones. For example, cloud infrastructure system 930 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 932 may be provided that are shared by different components or modules of cloud infrastructure system 902 and by the services provided by cloud infrastructure system 902. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 902 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 902, and the like.

In one embodiment, as depicted in the figure, cloud management functionality may be provided by one or more modules, such as an order management module 920, an order orchestration module 922, an order provisioning module 924, an order management and monitoring module 926, and an identity management module 928. These modules may include or be provided using one or more computers and/or servers, which may be general purpose computers, specialized server computers, server farms, server clusters, or any other appropriate arrangement and/or combination.

In exemplary operation 934, a customer using a client device, such as client computing device 904, 906 or 908, may interact with cloud infrastructure system 902 by requesting one or more services provided by cloud infrastructure system 902 and placing an order for a subscription for one or more services offered by cloud infrastructure system 902. For example, such an arrangement may be used by a customer/developer in order to have the web service computer system perform compilation and execution of the developer's code to be injected. In certain embodiments, the customer may access a cloud User Interface (UI), cloud UI 912, cloud UI 914 and/or cloud UI 916 and place a subscription order via these UIs. The order information received by cloud infrastructure system 902 in response to the customer placing an order may include information identifying the customer and one or more services offered by the cloud infrastructure system 902 that the customer intends to subscribe to. After an order has been placed by the customer, the order information is received via the cloud UIs, 912, 914 and/or 916.

At operation 936, the order is stored in order database 918. Order database 918 can be one of several databases operated by cloud infrastructure system 930 and operated in conjunction with other system elements. At operation 938, the order information is forwarded to an order management module 920. In some instances, order management module 920 may be configured to perform billing and accounting functions related to the order, such as verifying the order, and upon verification, booking the order. At operation 940, information regarding the order is communicated to an order orchestration module 922. Order orchestration module 922 may utilize the order information to orchestrate the provisioning of services and resources for the order placed by the customer. In some instances, order orchestration module 922 may orchestrate the provisioning of resources to support the subscribed services using the services of order provisioning module 924.

In certain embodiments, order orchestration module 922 enables the management of business processes associated with each order and applies business logic to determine whether an order should proceed to provisioning. At operation 942, upon receiving an order for a new subscription, order orchestration module 922 sends a request to order provisioning module 924 to allocate resources and configure those resources needed to fulfill the subscription order. Order provisioning module 924 enables the allocation of resources for the services ordered by the customer. Order provisioning module 924 provides a level of abstraction between the cloud services provided by cloud infrastructure system 900 and the physical implementation layer that is used to provision the resources for providing the requested services. Order orchestration module 922 may thus be isolated from implementation details, such as whether or not services and resources are actually provisioned on the fly or pre-provisioned and only allocated/assigned upon request.

At operation 944, once the services and resources are provisioned, a notification of the provided service may be sent to customers on client computing devices 904, 906 and/or 908 by order provisioning module 924 of cloud infrastructure system 902. At operation 946, the customer's subscription order may be managed and tracked by an order management and monitoring module 926. In some instances, order management and monitoring module 926 may be configured to collect usage statistics for the services in the subscription order, such as the amount of storage used, the amount of data transferred, the number of users, and the amount of system up time and system down time.

In certain embodiments, cloud infrastructure system 900 may include an identity management module 928. Identity management module 928 may be configured to provide identity services, such as access management and authorization services in cloud infrastructure system 900. In some embodiments, identity management module 928 may control information about customers who wish to utilize the services provided by cloud infrastructure system 902. Such information can include information that authenticates the identities of such customers and information that describes which actions those customers are authorized to perform relative to various system resources (e.g., files, directories, applications, communication ports, memory segments, etc.). Identity management module 928 may also include the management of descriptive information about each customer and about how and by whom that descriptive information can be accessed and modified.

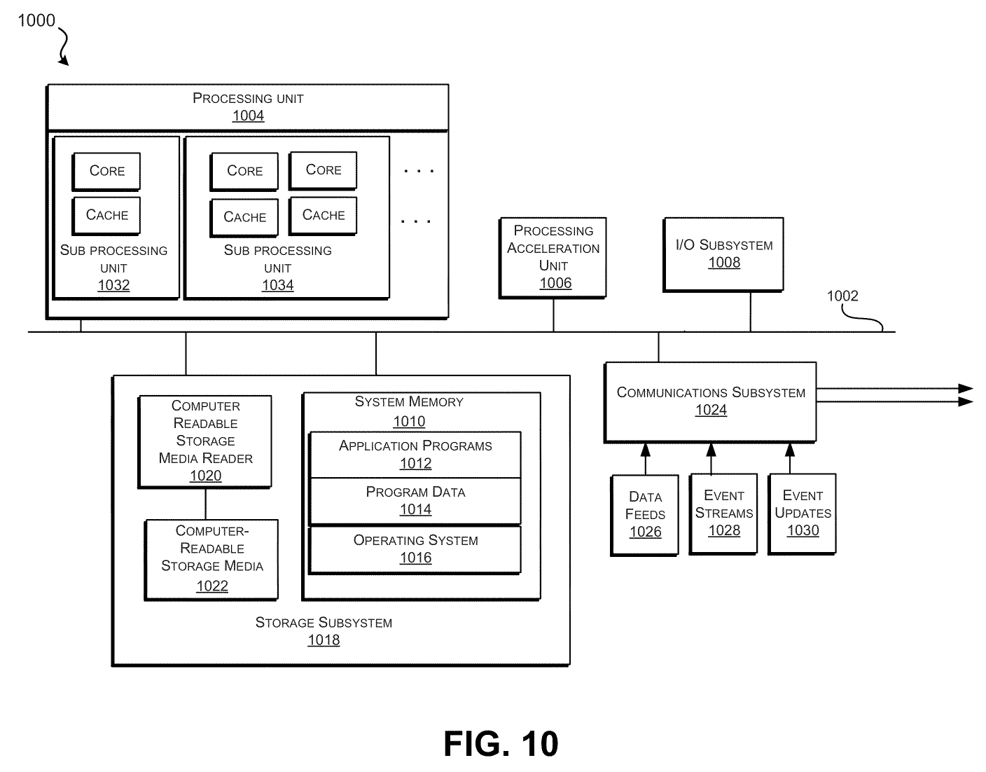

FIG. 10 illustrates an embodiment of a computer system 1000, which may be used to implement various embodiments detailed herein, such as the web service computer system, developer computer systems, and user computer systems. It should be understood that the previously described computer systems may include one or more instances of a computer such as computer system 1000. For instance, a group of servers may perform the functions of a web service computer system. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Ski® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that comprises software elements, shown as being currently located within a system memory 1010. System memory 1010 may store program instructions that are loadable and executable on processing unit 1004, as well as data generated during the execution of these programs.

Depending on the configuration and type of computer system 1000, system memory 1010 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1004. In some implementations, system memory 1010 may include multiple different types of memory, such as static random access memory (SRAM) or dynamic random access memory (DRAM). In some implementations, a basic input/output system (BIOS), containing the basic routines that help to transfer information between elements within computer system 1000, such as during start-up, may typically be stored in the ROM. By way of example, and not limitation, system memory 1010 also illustrates application programs 1012, which may include client applications, Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry®10 OS, and Palm® OS operating systems.

Storage subsystem 1018 may also provide a tangible computer-readable storage medium for storing the basic programming and data constructs that provide the functionality of some embodiments. Software (programs, code modules, instructions) that when executed by a processor provide the functionality described above may be stored in storage subsystem 1018. These software modules or instructions may be executed by processing unit 1004. Storage subsystem 1018 may also provide a repository for storing data used in accordance with the present invention.

Storage subsystem 1018 may also include a computer-readable storage media reader 1020 that can be further connected to computer-readable storage media 1022. Together and, optionally, in combination with system memory 1010, computer-readable storage media 1022 may comprehensively represent remote, local, fixed, and/or removable storage devices plus storage media for temporarily and/or more permanently containing, storing, transmitting, and retrieving computer-readable information.

Computer-readable storage media 1022 containing code, or portions of code, can also include any appropriate media known or used in the art, including storage media and communication media, such as, but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 1000.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 1002.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for performing a cost comparison of at least a first item and a second item, the method comprising:
receiving, by a computer system, a request for the cost comparison that identifies the first item and the second item;
based on the request, determining, by the computer system, a first cost bill of materials (BOM) structure for the first item and a second cost BOM structure for the second item;
comparing, by the computer system, the first cost BOM structure to the second cost BOM structure to identify a first group of entries that are common to the first cost BOM structure and the second cost BOM structure, the first group of entries comprising a plurality of components and resources;
identifying, by the computer system, a second group of entries present in the first cost BOM structure but not the second cost BOM structure;
identifying, by the computer system, a third group of entries present in the second cost BOM structure but not the first cost BOM structure;
determining, by the computer system, for each entry of each cost BOM structure, a cost associated with the entry; and
creating, by the computer system, a listing of the first group of entries, the second group of entries, and the third group of entries, wherein the first group of entries has, for at least one entry of the first group of entries, the first item is associated with a different cost than the second item.

2. The method for performing the cost comparison of claim 1, wherein the first item and the second item are a same type of item, but are manufactured at geographically-separated manufacturing facilities.

3. The method for performing the cost comparison of claim 1, wherein the cost for a first entry present on the first cost BOM structure and the second cost BOM structure comprises a cost related to overhead.

4. The method for performing the cost comparison of claim 3, wherein a second entry present on the first cost BOM structure and the second cost BOM structure is acquired from different suppliers for the first item and the second item.

5. The method for performing the cost comparison of claim 1, the method further comprising:
outputting, by the computer system, for presentation the listing of the first group of entries, the second group of entries, and the third group of entries in the form of a table to a user computer system from which the request was received.

6. The method for performing the cost comparison of claim 1, wherein the first group of entries is listed in the listing above the second group of entries and the third group of entries.

7. The method for performing the cost comparison of claim 5, wherein at least one entry of the first group of entries is comprised of a plurality of components, the method further comprising:
outputting, by the computer system, for presentation a first entry of the first group of entries as a collapsible field within the table, wherein:
the collapsible field, when collapsed, indicates a total cost for a subassembly of the first item and the second item, and
the collapsible field, when expanded, lists costs for each component of the subassembly for the first item and the second item.

8. A system for performing a cost comparison of at least a first item and a second item, the system comprising:
one or more processors; and
a memory communicatively coupled with and readable by the one or more processors and having stored therein processor-readable instructions which, when executed by the one or more processors, cause the one or more processors to:
receive a request for the cost comparison that identifies the first item and the second item;
based on the request, determine a first cost bill of materials (BOM) structure for the first item and a second cost BOM structure for the second item;
compare the first cost BOM structure to the second cost BOM structure to identify a first group of entries that are common to the first cost BOM structure and the second cost BOM structure, the first group of entries comprising a plurality of components and resources;
identify a second group of entries present in the first cost BOM structure but not the second cost BOM structure;
identify a third group of entries present in the second cost BOM structure but not the first cost BOM structure;
determine for each entry of each cost BOM structure, a cost associated with the entry; and
create a listing of the first group of entries, the second group of entries, and the third group of entries, wherein the first group of entries has, for at least one entry of the first group of entries, the first item is associated with a different cost than the second item.

9. The system for performing the cost comparison of claim 8, wherein the first item and the second item are a same type of item, but are manufactured at geographically-separated manufacturing facilities.

10. The system for performing the cost comparison of claim 8, wherein the cost for a first entry present on the first cost BOM structure and the second cost BOM structure comprises a cost related to overhead.

11. The system for performing the cost comparison of claim 10, wherein a second entry present on the first cost BOM structure and the second cost BOM structure is acquired from different suppliers for the first item and the second item.

12. The system for performing the cost comparison of claim 8, wherein the processor-readable instructions, when executed, further cause the one or more processors to:
output for presentation the listing of the first group of entries, the second group of entries, and the third group of entries in the form of a table to a user computer system from which the request was received.

13. The system for performing the cost comparison of claim 8, wherein the first group of entries is listed in the listing above the second group of entries and the third group of entries.

14. The system for performing the cost comparison of claim 12, wherein at least one entry of the first group of entries is comprised of a plurality of components, and the processor-readable instructions, when executed, further cause the one or more processors to:
output for presentation a first entry of the first group of entries as a collapsible field within the table, wherein:
the collapsible field, when collapsed, indicates a total cost for a subassembly of the first item and the second item, and
the collapsible field, when expanded, lists costs for each component of the subassembly for the first item and the second item.

15. A non-transitory processor-readable medium for performing a cost comparison of at least a first item and a second item, comprising processor-readable instructions configured to cause one or more processors to:
receive a request for the cost comparison that identifies the first item and the second item;
based on the request, determine a first cost bill of materials (BOM) structure for the first item and a second cost BOM structure for the second item;
compare the first cost BOM structure to the second cost BOM structure to identify a first group of entries that are common to the first cost BOM structure and the second cost BOM structure, the first group of entries comprising a plurality of components and resources;
identify a second group of entries present in the first cost BOM structure but not the second cost BOM structure;
identify a third group of entries present in the second cost BOM structure but not the first cost BOM structure;
determine for each entry of each cost BOM structure, a cost associated with the entry; and
create a listing of the first group of entries, the second group of entries, and the third group of entries, wherein the first group of entries has, for at least one entry of the first group of entries, the first item is associated with a different cost than the second item.

16. The non-transitory processor-readable medium for performing the cost comparison of claim 15, wherein the cost for a first entry present on the first cost BOM structure and the second cost BOM structure comprises a cost related to overhead.

17. The non-transitory processor-readable medium for performing the cost comparison of claim 16, wherein a second entry present on the first cost BOM structure and the second cost BOM structure is acquired from different suppliers for the first item and the second item.

18. The non-transitory processor-readable medium for performing the cost comparison of claim 15, wherein the processor-readable instructions are further configured to cause the one or more processors to:
output for presentation the listing of the first group of entries, the second group of entries, and the third group of entries in the form of a table to a user computer system from which the request was received.

19. The non-transitory processor-readable medium for performing the cost comparison of claim 15, wherein the first group of entries is listed in the listing above the second group of entries and the third group of entries.

20. The non-transitory processor-readable medium for performing the cost comparison of claim 18, wherein at least one entry of the first group of entries is comprised of a plurality of components, and the processor-readable instructions are further configured to cause the one or more processors to:
output for presentation a first entry of the first group of entries as a collapsible field within the table, wherein:
the collapsible field, when collapsed, indicates a total cost for a subassembly of the first item and the second item, and
the collapsible field, when expanded, lists costs for each component of the subassembly for the first item and the second item.
